(19) United States
(12) Patent Application Publication
(10) Pub. No.: US 2022/0171143 A1
(43) Pub. Date: Jun. 2, 2022

(54) CONNECTOR

(71) Applicant: NITTO DENKO CORPORATION, Osaka (JP)

(72) Inventors: Koichi TSUDA, Osaka (JP); Yusuke SHIMIZU, Osaka (JP); Satoshi ITO, Osaka (JP)

(73) Assignee: NITTO DENKO CORPORATION, Osaka (JP)

(21) Appl. No.: 17/441,525

(22) PCT Filed: Feb. 25, 2020
(86) PCT No.: PCT/JP2020/007315

§ 371 Date: Sep. 21, 2021

(30) Foreign Application Priority Data
Mar. 26, 2019 (JP) 2019-057696

(51) Int. Cl. G02B 6/42

(52) U.S. Cl. CPC G02B 6/4256; G02B 6/428

(57) ABSTRACT

A connector includes an optical fiber and a case, and converts an optical signal input from the optical fiber into an electrical signal and outputs the electrical signal, or converts an input electrical signal into an optical signal and outputs the optical signal to the optical fiber. The case has a wall into which the optical fiber is inserted. The rear wall has an upper end and a lower end facing each other with a space therebetween so that the optical fiber intervenes in the space. The case includes an upper protruding wall protruding in the front-rear direction and a lower protruding wall protruding in the front-rear direction. Between the upper free end of the upper protruding wall and the lower free end of the lower protruding wall, a first space is defined so the optical fiber can freely move in the width direction.

The present invention relates to a connector.

### TECHNICAL FIELD

There is a known connector including an optical fiber and a case accommodating the tip of the optical fiber.

### BACKGROUND ART

For example, there is a proposed connector including a box-shaped case, and an optical fiber inserted into a circle hole of the case (for example, see Patent Document 1). Further, there is another proposed connector that has the above-described structure, and a connector active optical cable (AOC) inserted therein and carrying out photoelectric conversion in the connector (for example, example, see Patent Document 1).

### CITATION LIST

### Patent Document

Patent Document 1: Japanese Patent Publication No. 6078667

Patent Document 2: Japanese Translation of PCT International Application Publication No. 2015-511334

Patent Document 3: Japanese Translation of PCT International Application Publication No. 2015-502574

Patent Document 1: Japanese Patent Publication No. 6399365

### SUMMARY OF THE INVENTION

### Problem to be Solved by the Invention

However, in the connectors described in Patent Document 1 to 4, the optical fiber is bound in the circle hole of the cable. Thus, when an external force acts on the optical fiber, the optical fiber is damaged. Then, there are disadvantages that the reliability of transmission of optical signals is drastically reduced in the connector.

The present invention provides a connector that can suppress the damage to the optical fiber.

### Means for Solving the Problem

The present invention [1] includes a connector for converting an optical signal input from an optical fiber into an electrical signal and outputting the electrical signal electrical signal or converting an input electrical signal into an optical signal and outputting the optical signal to the optical fiber, the connector comprising: the optical fiber; and a case accommodating one edge in a longitudinal direction of the optical fiber in the case, wherein the case has a case wall into which the optical fiber is inserted, the case wall has a first end and a second end facing each other with a space so that the optical fiber intervenes between the first end and the second end, the case further includes: a first wall protruding from the first end along a moving away direction in which the optical fiber moves away from the case wall; and a second wall protruding from the second end along the moving away direction, and a space is defined between a free end in a protruding direction in which the first wall protrudes and a free end in a protruding direction in which the second wall protrudes so that the optical fiber passing between the free ends can freely move in an orthogonal direction orthogonal to a facing direction in which the first wall faces the second wall and both of the protruding directions of the first wall and the second wall.

In the connector, even when an external force acts from the outside in the facing direction, the damage to the optical fiber can be suppressed by the first wall and second wall protruding from the first end and second end facing each other and holding the optical fiber therebetween.

Meanwhile, the first wall and second wall each have the free end that allows the movement of the optical fiber in the orthogonal direction. Thus, the binding of the optical fiber by the first wall and the second wall is loosened.

Thus, the loosening of the binding of the optical fiber by the first wall and second wall suppresses the damage to the optical fiber, in other words, suppresses the damage to the optical fiber, which is caused by an external force from the outside in the facing direction.

The present invention [2] includes the connector described in [1] above, further comprising a printed wiring board in the case, wherein the one edge in the longitudinal direction of the optical fiber is connected to the printed wiring board, a photoelectric conversion member is mounted on the printed wiring board, and the printed wiring board is disposed along the orthogonal direction.

In the connector, while the movement of the optical fiber in a direction in which the printed wiring board is disposed is allowed, the movement of the optical fiber in the facing direction is limited. Thus, the release of the one edge in the longitudinal direction of the optical fiber from the printed wiring board can be suppressed.

The present invention [3] includes the connector described in [2] above, further comprising a terminal connected to the printed wiring board and capable of inputting and outputting the electrical signal, wherein the terminal protrudes from the case in a reverse direction of the protruding directions, a length in the orthogonal direction of the terminal is longer than a length in the facing direction of the terminal.

The insertion of the terminal to an electronic device facilitates the movement of the case, additionally, of the optical fiber in the facing direction. However, in the connector, the first wall and second wall suppress the movement of the optical fiber in the facing direction. Thus, damage to the optical fiber can further be suppressed.

The present invention [4] includes the connector described in any one of the above-described [1] to [3], a third wall connecting an end in the orthogonal direction of the first wall to an end in the orthogonal direction of the second wall, and a fourth wall connecting the other end in the orthogonal direction of the first wall to the other end in the orthogonal direction of the second wall.

In the connector, the third wall and fourth wall can suppress the damage to the optical fiber, which is caused by an external force from the outside in the orthogonal direction.

The present invention [5] includes the connector described in any one of the above-described [1] to [4], wherein the first wall and/or the second wall each have/has a penetrating hole penetrating in a thickness direction.

With the connector, the user can surely move the case in the longitudinal direction by pinching the third wall and fourth wall with the two fingers and putting another finger into the penetrating hole.

The present invention [6] includes the connector described in [5] above, wherein a peripheral edge defining the penetrating hole includes a downstream edge in the protruding direction, and the downstream edge in the protruding direction has an approximately straight line shape along the orthogonal direction.

When a force acts downstream in the protruding direction by hooking the finger into the first rear edge, the force acting in a withdrawal direction in which the terminal is withdrawn is increased, and the terminal can smoothly be withdrawn from the electronic device.

The present invention [7] includes the connector described in [4] above, wherein the first wall and/or the second wall each have/has a concave portion hollowed from an outer surface toward an inside in the facing direction.

With the connector, the user can surely move the case in the longitudinal direction by pinching the third wall and fourth wall with the two fingers and putting another finger into the concave portion.

The present invention [8] includes the connector described in [7] above, wherein a peripheral edge defining the concave portion includes a downstream edge in the protruding direction, and the downstream edge in the protruding direction has an approximately straight line along the orthogonal direction.

When a force acts downstream in the protruding direction by hooking the finger into the downstream edge in the protruding direction, the force acting in the withdrawal direction is increased, and the terminal can smoothly be withdrawn from the electronic device.

The present invention [9] includes the connector described in any one of the above-described [1] to [8], wherein the first wall and the second wall have a flexural modulus of 3 GPa or more at 25° C.

The connector has a flexural modulus of 3 GPa or more, namely a high flexural modulus. Thus, the damage to the optical fiber, which is caused by an external force from the outside in the facing direction, can more surely be suppressed.

### EFFECTS OF THE INVENTION

The connector of the present invention can suppress damage to the optical fiber.

### BRIEF DESCRIPTION OF THE DRAWINGS

FIG. 1 is an exploded perspective view of an embodiment of the connector of the present invention.

FIGS. 2A to 2D illustrate the connector of FIG. 1. FIG. 2A is a lateral view arrow A direction. FIG. 2B is a lateral cross-sectional view taken along line B-B. FIG. 2C is a rear view m an arrow C direction. FIG. 2D is a front elevation view in an arrow D direction.

FIG. 3 is an exploded perspective view of the connector of FIG. 1.

FIGS. 4A and 4B illustrate the insertion and withdrawal of a terminal. FIG. 4A illustrates the insertion of the terminal into a laptop computer. FIG. 4B illustrates the withdrawal of the terminal from the laptop computer.

FIGS. 5A and 5B illustrate a variation of the connector depicted in FIG. 1 and FIG. 2B (a variation in which the first wall has the first concave portion, and the second wall has the second concave portion). FIG. 5A is an enlarged perspective view thereof. FIG. 5B is a sectional side view thereof.

### DESCRIPTION OF THE EMBODIMENTS

<Embodiment>

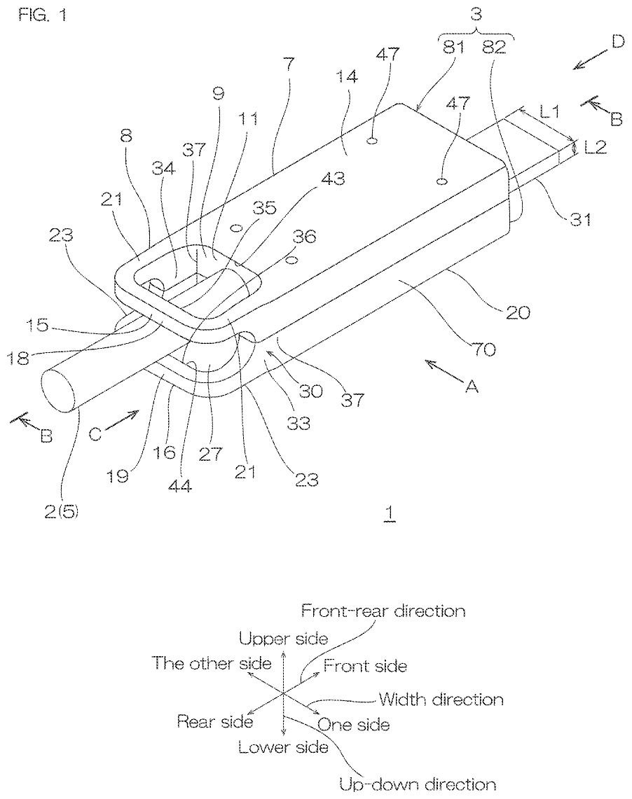

An embodiment of the connector of the present invention will be described with reference to FIGS. 1 to 3.

A front-rear direction illustrated in FIGS. 1 to 3 is an example of a direction in which an optical fiber 5 (described below. In this paragraph, this will apply to the following members.) moves away from a rear wall 9 and its reverse direction. An up-down direction illustrated in FIGS. 1 to 3 is an example of a facing direction in which an upper protruding wall 15 faces a lower protruding wall 16. A width direction illustrated in FIGS. 1 to 3 is an example of a direction orthogonal to the above-described moving away direction and the facing direction. For details, each of the directions conforms to each direction illustrated in FIGS. 1 to 3.

A connector 1 can convert an optical signal input from the optical fiber 5 described below into an electrical signal, and output the electrical signal to a terminal 31 described below, or can convert an electrical signal input to the terminal 31 into an optical signal, and output the optical signal to the optical fiber 5. The connector 1 includes an optical fiber cable 2, a case 3, and a printed wiring board 50.

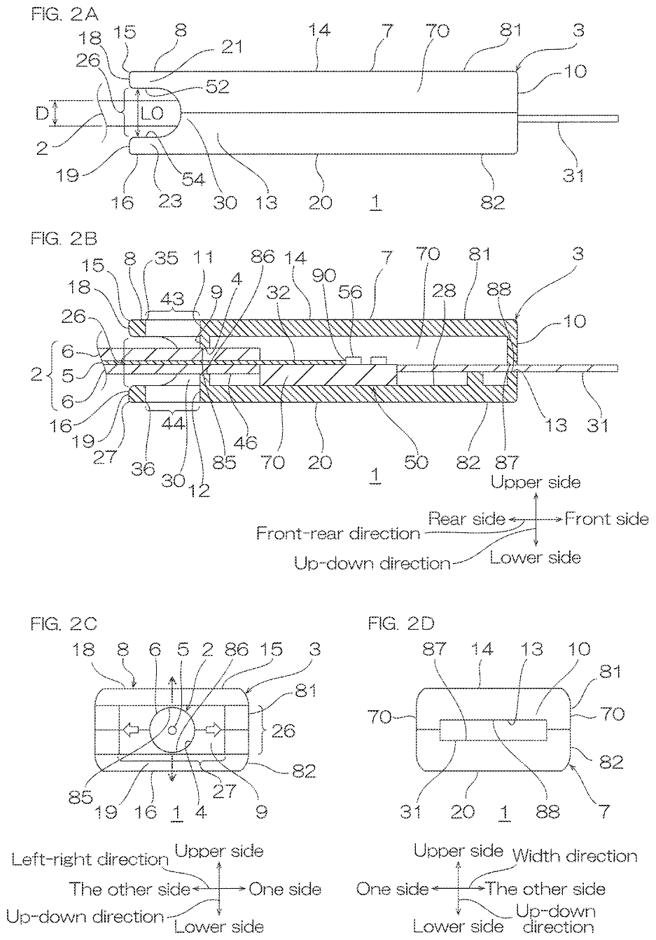

The optical fiber cable 2 has a shape extending in a longitudinal direction. As illustrated in FIG. 2B and FIG. 2C, the optical fiber cable 2 includes the optical fiber 5 and a sheath 6.

The optical fiber 5 extends in the longitudinal direction and has, for example, an approximately circular shape in the cross-sectional view. Examples of the material of the optical fiber 5 include transparent materials including resins such as acryl resins and epoxy resins, and ceramics such as glass. As the transparent material, for flexibility, resin is preferably is used.

The sheath 6 covers an outer peripheral surface of the optical fiber 5 and has, for example, an approximately toric (ring) shape in the cross-sectional view. Specifically, the sheath 6 has an approximately cylindrical tubular shape having a common axis with the optical fiber 5. Examples of the material of the sheath 6 include flexible materials such as resins (for example, polyolefin, and polyvinyl chloride). At 25° C., the sheath 6 has a flexural modulus lower than those of an upper protruding wall 15 and a lower protruding wall 16 described below. Specifically, the flexural modulus is, for example, 2.5 GPa or less, preferably 1 GPa or less, more preferably 0.11 GPa or less and, for example, 0.0001 GPa or more.

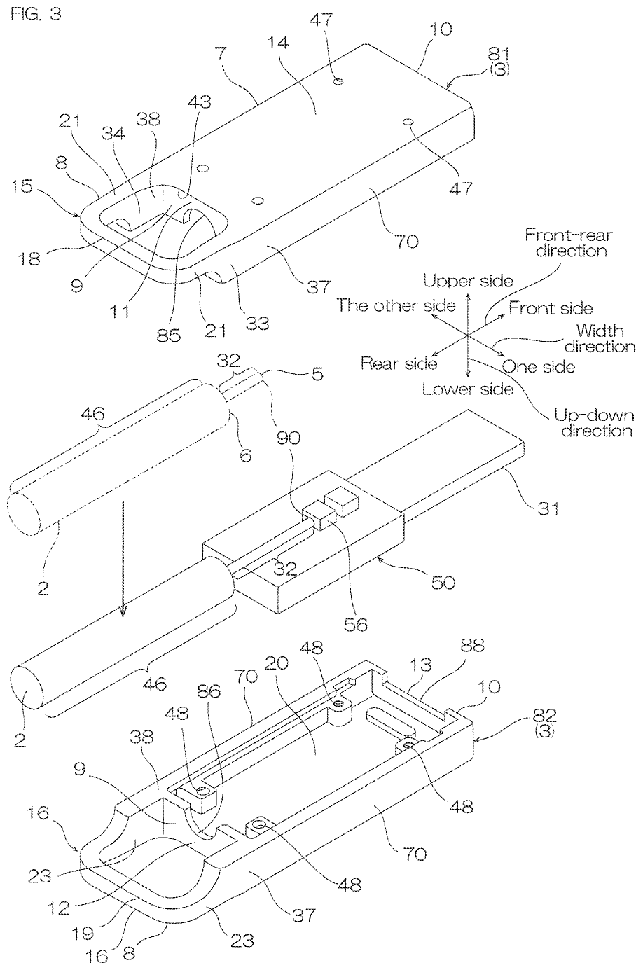

As illustrated in FIG. 2B and FIG. 3, the optical fiber cable 2 further includes a cover portion 46 and an exposure portion 32 in order in the longitudinal direction.

In the cover portion 46, the above-described sheath 6 covers the optical fiber 5. In other words, the cover portion 46 includes the optical fiber 5 and the sheath 6.

Meanwhile, in the exposure portion 32, the sheath 6 is removed. In this manner, the outer peripheral surface of the optical fiber 5 is exposed. In other words, the exposure portion 32 does not include the sheath 6, and includes only the optical fiber 5. The exposure portion 32 includes a front edge 90 as an example of one edge in the longitudinal direction of the optical fiber 5.

The size of the optical fiber cable 2 is appropriately set depending on the use and purpose. The maximum length (specifically, diameter) D of the cover portion 46 in the cross-sectional view is, for example, 1 mm or more, preferably 2 mm or more and, for example, 10 mm or less, preferably 6 mm or less.

As illustrated in FIG. 1 to FIG. 3, the case 3 includes an accommodating portion 7, a protruding portion 8, and a protective portion 30.

The accommodating portion 7 accommodates the front edge 90 of the optical fiber 5 therein. The accommodating portion 7 has a box shape and, specifically, integrally includes six case walls consisting of the rear wall 9, a front wall 10, an upper wall 14, a bottom wall 20 and both-sides walls 70.

The rear wall 9 has an approximately rectangular board shape. Specifically, the rear wall 9 has an upper end 11 as an example of a first end, a lower end 12 as an example of a second end, and both side ends 37. The upper end 11 and the lower end 12 are disposed with a space therebetween and face each other. In a direction in which the upper end 11 and the lower end 12 extend, the both side ends 37 connect an end of the upper end 11 to an end of the lower end 12, and connect the other end of the upper end 11 to the other end of the lower end 12, respectively. The rear wall 9 has an insertion hole 4 penetrating in the thickness direction of the rear wall 9 (corresponding to the front-rear direction).

The insertion hole 4 intervenes between the upper end 11 and the lower end 12. The insertion hole 4 is formed at a central part of the rear wall 9 in the thickness direction and the width direction. The insertion hole 4 has an approximately circular shape. The size of the insertion hole 4 corresponds to that of the optical fiber cable 2 (the cover portion 46), specifically, the insertion hole 4 has the same size as the optical fiber cable 2.

As illustrated in FIG. 2D, the front wall 10 has an approximately rectangular frame board shape. As illustrated in FIG. 2B, the front wall 10 faces a front side of the rear wall 9 with a space therebetween. The front wall 10 has a terminal insertion hole 13 into which a terminal 31 described below is inserted.

As illustrated in FIG. 1, the upper wall 14 has an approximately rectangular board shape. As illustrated in FIG. 2B, the upper wall 14 connects the upper end 11 of the rear wall 9 to an upper end of the front wall 10 in the front-rear direction.

The bottom wall 20 is disposed under a lower side of the upper wall 14 with a space therebetween. The bottom wall 20 has an approximately rectangular board shape. The bottom wall 20 connects the lower end 12 of the rear wall 9 to a lower end of the front wall 10 in the front-rear direction.

The both-sides walls 70 each have an approximately rectangular board shape. One of the both-sides walls 70 connects the one-side end in the width direction of the upper wall 14 to the one-side end in the width direction of the bottom wall 20. The other of the both-sides walls 70 connects the other-side end in the width direction of the upper wall 14 to the other-side end in the width direction of the bottom wall 20.

The case 3 has a flat box shape in which the upper wall 14 and the bottom wall 20 each have a larger length in the width direction than that of each of the both-sides walls 70 in up-down direction.

The protruding portion 8 protrudes from the rear wall 9 backward (in an exemplary direction of the moving away direction). Specifically, the protruding portion 8 independently includes the upper protruding wall 15 as an example of the first wall protruding backward from the upper end 11 of the rear wall 9, and the lower protruding wall 16 as an example of the second wall protruding backward from the lower end 12 of the rear wall 9.

The upper protruding wall 15 has an approximately rectangular board shape having a common side with the upper end 11 of the rear wall 9.

The upper protruding wall 15 has an upper penetrating hole 43 penetrating in the thickness direction of the upper protruding wall 15 (corresponding to the up-down direction). The upper penetrating hole 43 has an approximately rectangular shape extending from the central part in the width direction of the upper end 11 of the rear wall 9 to the central part in the front-rear direction of the upper protruding wall 15 in the plan view. The four corners of the upper penetrating hole 43 each have an approximately curved shape in the plan view. The upper protruding wall 15 integrally includes an upper free end 18 and both upper protruding sides 21. The upper free end 18 and both upper protruding sides 21 are defined by the upper penetrating hole 43.

The upper free end 18 is disposed at a rear side of the upper end 11 of the rear wall 9 with a space (in which the upper penetrating hole 43 is formed) therebetween. The upper free end 18 has a strip shape extending along the width direction. (Rear edges of) both ends in the width direction of the upper free end 18 each have an approximately curved shape in the plan view.

The both upper protruding sides 21 hold the upper penetrating hole 43 therebetween in the width direction. The both upper protruding sides 21 extend backward from both ends in the width direction of the upper end 11 and reach both ends in width direction of the upper free end 18, respectively.

The peripheral edge (the inner peripheral edge) defining the upper penetrating hole 43 includes a first rear edge 35 as an example of a downstream edge in the protruding direction. The first rear edge 35 has an approximately straight line shape along the width direction.

The lower protruding wall 16 is disposed at and faces a lower side of the upper protruding wall 15 with a space therebetween. Meanwhile, the lower protruding wall 16 has a symmetrical shape with respect to an imaginary plane passing through the center of the insertion hole 4 and along the front-rear direction and the width direction to the upper protruding wall 15.

Specifically, the lower protruding wall 16 has an approximately rectangular board shape having a common side with the lower end 12 of the rear wall 9.

The lower protruding wall 16 has a lower penetrating hole 44 in the thickness direction of the lower protruding wall 16 (corresponding to the up-down direction). The lower penetrating hole 44 has an approximately rectangular shape extending from the central part in the width direction of the lower end 12 of the rear wall 9 to the central part in the front-rear direction of the lower protruding wall 16 in the plan view. The four corners of the lower penetrating hole 44 each have an approximately curved shape in the plan view. The lower protruding wall 16 integrally includes a lower free end 19 and both lower protruding sides 23 defined by the lower penetrating hole 44.

The lower free end 19 is disposed at a rear side of the lower end 12 of the rear wall 9 with a space (in which the lower penetrating hole 44 is formed) therebetween. The lower free end 19 has a strip shape extending along the width direction. (Rear edges of) both ends in the width direction of the lower free end 19 each have an approximately curved shape in the plan view.

The both lower protruding sides 23 hold the lower penetrating hole 44 therebetween in the width direction. The both lower protruding sides 23 extend backward from both ends in the width direction of the lower end 12 and reach both ends in width direction of the lower free end 19, respectively.

The peripheral edge (the inner peripheral edge) defining the lower penetrating hole 44 includes a second rear edge 36 as an example of a downstream edge in the protruding direction. The second rear edge 36 has an approximately straight line shape along the width direction.

A first space 26 is defined between the upper free end 18 of the upper protruding wall 15 and the lower free end 19 of the lower protruding wall 16. The first space 26 enables the optical fiber cable 2 passing between the upper free end 18 and the lower free end 19 to freely move in the width direction (an example of a direction orthogonal to the facing direction of the upper protruding wall 15 and the lower protruding wall 16 and both of the protruding directions of the upper protruding wall 15 and the lower protruding wall 16).

The first space 26 has an up-down direction length (a space in the facing direction of the upper protruding wall 15 and the lower protruding wall 16) L0 that is a distance between the upper free end 18 and the lower free end 19. Specifically, the up-down direction length L0 is, for example, 3 mm or more, preferably 5 mm or more and, for example, 10 mm or less, preferably 8 mm or less.

The ratio (D/L0) of the maximum length D of the optical fiber cable 2 to the up-down direction length L0 of the first space 26 in the cross-sectional view is, for example, less than 1, preferably 0.8 or less, more preferably 0.6 or less, and 0.1 or more, preferably 0.3 or more.

The protective portion 30 independently includes a third wall 33 that connects the one side in the width direction of the both upper protruding sides 21 to the one side in the width direction of the both lower protruding sides 23, and a fourth wall 34 that connects the other side in the width direction of the both upper protruding sides 21 to the other side in the width direction of the both lower protruding sides 23.

The third wall 33 and the fourth wall 34 have shapes extending backward from the both side ends 37 of the rear wall 9, respectively. Specifically, the third wall 33 and the fourth wall 34 are symmetric relative to an imaginary plane passing through the center of the insertion hole 4 and extending in the front-rear direction and the up-down direction. The protruding ends (rear ends) of the third wall 33 and the fourth wall 34 are located nearer to the front side (base end side) relative to the upper free end 18 and the lower free end 19.

In this manner, along the up-down direction and the width direction, in the cross-sectional view overlapping the upper free end 18 and the lower free end 19, the first space 26 is defined by the upper free end 18 and the lower free end 19 (specifically, an upper edge and lower edge of the first space 26 are closed by the upper free end 18 and the lower free end 19). Meanwhile, both sides in the width direction of the first space 26 communicate with the outside.

Meanwhile, along the up-down direction and the width direction, in the cross-sectional view overlapping the third wall 33 and the fourth wall 34, a second space 27 located at a front side of the first space 26 is defined by the third wall 33 and the fourth wall 34 (specifically, both edges in the width direction of the second space 27 are closed by the third wall 33 and the fourth wall 34). Upper and lower sides of the second space 27 communicate with (are open to) the outside through the upper penetrating hole 43 and the lower penetrating hole 44, respectively. The second space 27 communicates with the first space 26 in the front-rear direction.

The optical fiber cable 2 of the protruding portion 8 has a part corresponding to the first space 26. The part is held between the upper free end 18 and the lower free end 19 in the up-down direction. The optical fiber cable 2 of the protruding portion 8 has a part corresponding to the second space 27. The part is held by the third wall 33 and the fourth wall 34 in the width direction.

The material of the case 3 is, for example, hard, specifically, is harder than the sheath 6 of the optical fiber cable 2. Specifically, the material has a flexural modulus at 25° C. of, for example, 1 GPa or more, preferably 3 GPa or more, more preferably 5 GPa or more, even more preferably 10 GPa or more and, for example, 100 GPa or less.

When the flexural modulus of the material of the case 3 (particularly, the flexural modulus of the material of the upper protruding wall 15 and the lower protruding wall 16) is the above-described lower limit or more, the damage to the optical fiber cable 2, which is caused by the action of an external force on the optical fiber cable 2 of the first space 26, can surely be suppressed.

Specifically, examples of the material of the case 3 include metals such as aluminum, stainless steel, and iron, and rigid plastics such as polyacetal, polyamide, polycarbonate, modified polyphenylene ether, and polybutylene telephthalate. Preferably, a metal is used.

The surface of the case 3 is subjected to surface finishing such as painting or plating.

As illustrated in FIG. 3, the accommodating portion 7, protruding portion 8, and protective portion 30 of the case 3 are made from two members, specifically, an upper portion 81 and a lower portion 82. The upper portion 81 consists of: the whole part of the upper wall 14; upper half parts of the rear wall 9, front wall 10, and both-sides walls 70 in the accommodating portion 7; the whole part of the upper protruding wall 15; and upper half parts of the third wall 33 and the fourth wall 34 in the protruding portion 8. The lower portion 82 consists of: the whole part of the bottom wall 20; lower half parts of the rear wall 9, front wall 10, and the both-sides walls 70 in the accommodating portion 7; the whole part of the lower protruding wall 16; and lower half parts of the third wall 33 and fourth wall 34 in the protruding portion 8.

The upper portion 81 and lower portion 82 have a first groove 85 and a second groove 86, which are provided for forming the insertion hole 4 on the rear wall 9, respectively. The first groove 85 and second groove 86 each have an approximately half arc shape.

Further, the upper portion 81 and the lower portion 82 have a third groove 87 and a fourth groove 87, which are provided for forming the terminal insertion hole 13 on the front wall 10, respectively.

A screw hole 47 is formed on the upper wall 14 of the upper portion 81 so that a screw not illustrated can be inserted into the screw hole 47. Meanwhile, a female screw 48 corresponding to the screw hole 47 is formed on the bottom wall 20 of the lower portion 82 so that a screw not illustrated can be screwed into the female screw 48.

As illustrated in FIG. 2B and FIG. 3, the printed wiring board 50 is accommodated in the accommodating portion 7. The printed wiring board 50 has an approximately rectangular board shape extending in the front-rear direction. Specifically, the printed wiring board 50 extends long in the front-rear direction and extends short in the width direction.

The printed wiring board 50 includes a photoelectric conversion member 56 and a terminal 31. The printed wiring board 50 may include, for example, an IC in addition to the above-described.

The photoelectric conversion member 56 is mounted on an upper surface of the printed wiring board 50. For example, the front edge 90 of the optical fiber cable 2 is optically connected to the photoelectric conversion member 56. Examples of the photoelectric conversion member 56 include a photodiode (PD) that can convert an optical signal input from the optical fiber 5 into an electrical signal and output the electrical signal to the terminal 31. Examples of the photoelectric conversion member 56 include a laser diode and a light-emitting diode that can convert an input electrical signal into an optical signal and output the optical signal to the optical fiber 5.

The terminal 31 can output the electrical signal input from the photoelectric conversion member 56 to an electronic device. Alternatively, the electrical signal can be input to the terminal 31 from an electronic device. Alternatively, to transmit, for example, an actuating signal, an electrical signal can directly be input or output from the terminal 31 without the conversion of the optical signal and the electrical signal. The terminal 31 is disposed on a front end surface of the printed wiring board 50. A free end of the terminal 31 protrudes frontward from the accommodating portion 7 (in an exemplary direction opposite to a direction in which the protruding portion 8 protrudes). An intermediate part in the front-rear direction of the terminal 31 is inserted in the terminal insertion hole 13 of the front wall 10. The terminal 31 has a length L1 in the width direction and a length L2 in the up-down direction. The length L1 is longer than the length L2.

To produce the connector 1, first, the optical fiber cable 2 is prepared as illustrated with the phantom line in FIG. 3.

Subsequently, the sheath 6 at one end in in the longitudinal direction of the optical fiber cable 2 is released from the outer peripheral surface of the optical fiber 5 to form the exposure portion 32.

As illustrated with a solid line in FIG. 3, thereafter, the tip of the exposure portion 32 of the optical fiber cable 2 is optically connected to the photoelectric conversion member 56 of the printed wiring board 50. Simultaneously, the front edge 90 of the optical fiber 5 is adhered to an upper surface of the printed wiring board 50.

Next, the optical fiber cable 2 is inserted into the insertion hole 4 of the case 3, and the terminal 31 is inserted into the terminal insertion hole 13.

Specifically, first, the upper portion 81 and the lower portion 82 are prepared. Next, the printed wiring board 50 is mounted on the bottom wall 20 of the lower portion 82, and the cover portion 46 of the optical fiber cable 2 is fitted into the second groove 86 of the lower portion 82. Simultaneously, the terminal 31 is fitted into the fourth groove 87 of the lower portion 82.

Next, the upper portion 81 is disposed on an upper side of the lower portion 82, and the first groove 85 and the second groove 86 hold the cover portion 46 therebetween. Simultaneously, the third groove 87 and the fourth groove 87 hold the terminal 31 therebetween.

In this manner, the case 3 having the insertion hole 4 and the terminal insertion hole 13 is produced. The insertion hole 4 is made from the first groove 85 and second groove 86, and the optical fiber cable 2 is inserted therein. The terminal insertion hole 13 is made from the third groove 87 and fourth groove 87, and the terminal 31 is inserted therein.

Thereafter, the screw not illustrated is inserted into the screw hole 47 of the upper portion 81. The tip of the screw is screwed into the female screw 48. In this manner, the upper portion 81 is fixed to the lower portion 82. The front edge 90 and the base end of the terminal 31 of the optical fiber cable 2 are fixed to the case 3.

In this manner, the connector 1 including the optical fiber cable 2, the case 3, and the printed wiring board 50 is produced.

Next, the insertion and withdrawal of the terminal 31 of the connector 1 into/from an insertion terminal 84 of a laptop computer 83 that is an example of the electronic device, and the transmission of the optical signal and the electrical signal will be described.

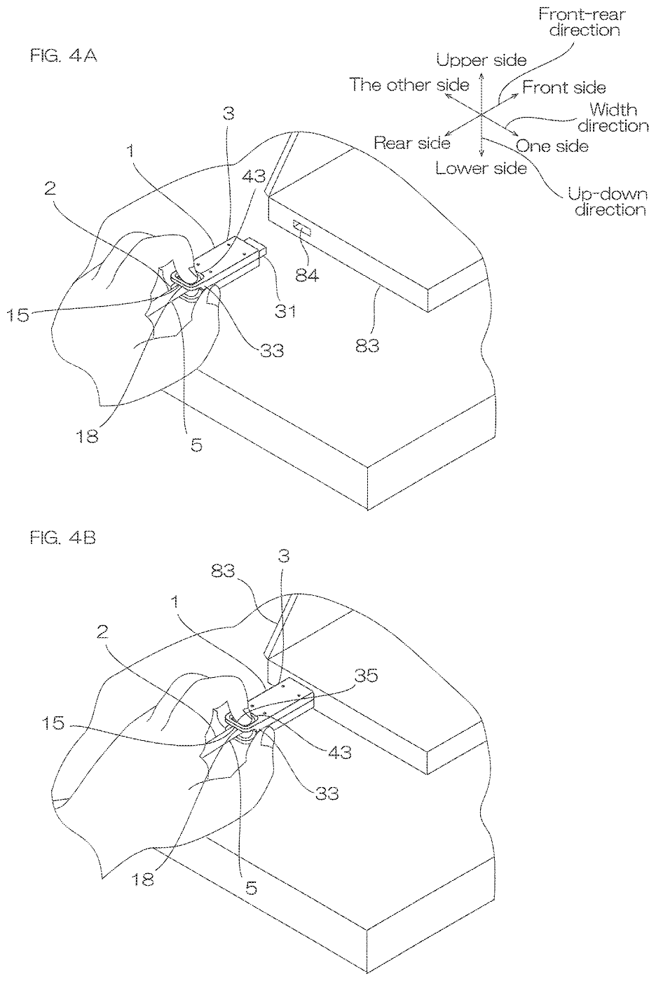

As illustrated in FIG. 4A, for example, three fingers contact the third wall 33 and the fourth wall 34 (not illustrated in FIG. 4A) and the peripheral edge defining the upper penetrating hole 43 on the upper protruding wall 15 to hold the case 3 and insert (put) the terminal 31 into the insertion terminal 84. In this manner, the connector 1 and the laptop computer 83 are electrically connected.

Subsequently, an example in which the photoelectric conversion member 56 is a photodiode will be described with reference to FIG. 2B and FIG. 3. In this example, an optical signal is input from the optical fiber 5 to the photoelectric conversion member 56, and the optical signal is converted into an electrical signal in the photoelectric conversion member 56. Thereafter, the electrical signal is input through the terminal 31 to the insertion terminal 84.

Further, an example in which the photoelectric conversion member 56 is a laser diode will be described. In this example, the electrical signal input from the insertion terminal 84 to the terminal 31 is transmitted to the photoelectric conversion member 56, and the photoelectric conversion member 56 coverts the electrical signal into an optical signal. Thereafter, the optical signal is input to the optical fiber 5.

Examples of the electrical signal and the optical signal include signals related to images and voice.

Thereafter, the three fingers contact the third wall 33 and the fourth wall 34 (not illustrated in FIG. 4A) and the peripheral edge defining the upper penetrating hole 43 on the upper protruding wall 15 to hold the case 3 and withdraw (remove) the terminal 31 from the insertion terminal. Particularly, the index finger (the central finger among the three finger) is put into the upper penetrating hole 43 and the inside part (pad) of the index finger is strongly pushed (pressed) backward against the first rear edge 35. In this manner, the electrical connection between the connector 1 and the laptop computer 83 is disconnected.

Thus, in the connector, even when an external force acts from the outside in the up-down direction, the upper protruding wall 15 and the lower protruding wall 16, which protrude from the upper free end 18 and lower free end 19 facing each other so that the optical fiber cable 2 intervenes therebetween, can suppress the damage to the optical fiber 5.

Meanwhile, the upper protruding wall 15 and the lower protruding wall 16 have their free ends, namely, the upper free end 18 and the lower free end 19 that allow for the movement of the optical fiber cable 2 in the width direction. Thus, the binding of the optical fiber cable 2 by the upper protruding wall 15 and the lower protruding wall 16 is loosened.

Accordingly, based on the loosening of the binding of the optical fiber cable 2 by the upper protruding wall 15 and the lower protruding wall 16, the damage to the optical fiber 5 can be suppressed, in other words, the damage to the optical fiber 5, which is caused by an external force from the outside in the up-down direction, can be suppressed.

While the movement of the optical fiber cable 2 in the width direction in which the printed wiring board 50 is disposed is allowed, the movement of the optical fiber cable 2 in the up-down direction is limited. Thus, the release of the front edge 90 of the optical fiber 5 from the printed wiring board 50 can be suppressed.

The insertion of the terminal 31 to the insertion terminal 84 facilitates the movement of the case 3 and additionally the optical fiber cable 2 in the facing direction. However, in the connector 1, the upper protruding wall 15 and the lower protruding wall 16 suppress the movement of the optical fiber cable 2 in the up-down direction. Thus, the damage to the optical fiber 5 can further be suppressed.

Further, in the connector 1, the third wall 33 and the fourth wall 34 can suppress the damage to the optical fiber 5, which is caused by an external force from both of the outsides in the width direction, can be suppressed.

With the connector 1, the user can surely move the case 3 along the longitudinal direction by pinching the third wall 33 and the fourth wall 34 with the thumb and the middle finger and putting the index finger into the upper penetrating hole 43.

With the connector 1, when a force acts downstream in the protruding direction by hooking the finger into the first rear edge 35, the force acting in the withdrawal direction is increased. Thus, the terminal 31 can smoothly be withdrawn from the insertion terminal 84.

In the connector 1, the upper protruding wall 15 and lower protruding wall 16 of the connector 1 have a flexural modulus of 3 GPa or more, namely, a high flexural modulus. Thus, the damage to the optical fiber 5, which is caused by an external force from the outside in the up-down direction, can more surely be suppressed.

<Variations>In each of the following variations, the same members and steps as in the first embodiment will be given the same numerical references and the detailed description thereof will be omitted. Further, each of the variations has the same operations and effects as those of the first embodiment unless especially described otherwise. Furthermore, the first embodiment and the variations can appropriately be combined.

In the embodiment, in the case 3, the lengths of the upper wall 14 and the bottom wall 20 in the width direction are larger than those of the both-sides walls 70 in the up-down direction. However, although not illustrated, the lengths of the upper wall 14 and the bottom wall 20 in the width direction may be smaller than those of the both-sides walls 70 in the up-down direction. In such a case, the printed wiring board 50 is disposed along the up-down direction in the case 3.

In the embodiment, the case 3 includes the third wall 33 and the fourth wall 34. However, although not illustrated, for example, the case 3 does not necessarily include the third wall 33 and the fourth wall 34. In the variation, a second space 27 communicates with both of the outsides in the width direction. In such a case, to insert or withdraw the terminal 31, the two fingers contact the both-sides walls 70.

Preferably, as the embodiment, the case 3 includes the third wall 33 and the fourth wall 34. In this manner, the damage to the optical fiber 5, which is caused by an external force acting on the optical fiber 5 from the outside in the up-down direction, can more surely be suppressed.

In the embodiment, the first rear edge 35 defining the upper penetrating hole 43 on the upper protruding wall 15 has an approximately straight line shape along the orthogonal direction. However, the shape is not limited to the above-described, and, for example, can be a curved shape, although not illustrated.

Preferably, the first rear edge 35 has an approximately straight line shape along the orthogonal direction. In this case, the first rear edge 35 has an approximately straight line shape in the width direction. Thus, when the terminal 31 is withdrawn backward, the force that acts in the withdrawal direction can be increased.

Further, in the embodiment, the upper protruding wall 15 includes the upper penetrating hole 43. However, the upper protruding wall 15 does not necessarily include the upper penetrating hole 43. Preferably, the upper protruding wall 15 includes the upper penetrating hole 43. In this manner, the user can surely move the case 3 along the longitudinal direction by hooking the finger into the upper penetrating hole 43.

Furthermore, in the embodiment, the lower protruding wall 16 includes the lower penetrating hole 44. However, the lower protruding wall 16 does not necessarily include the lower penetrating hole 44.

In the embodiment, the upper penetrating hole 43 and the lower penetrating hole 44 are formed on the upper protruding wall 15 and the lower protruding wall 16, respectively. However, only the upper penetrating hole 43 may be formed without the lower penetrating hole 44, and vice versa.

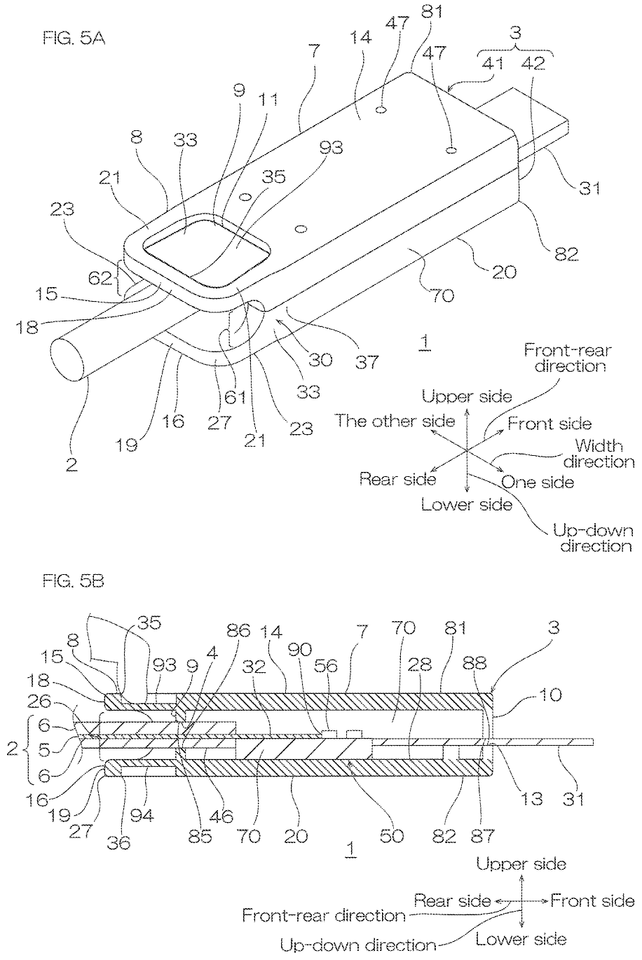

Furthermore, in place of the upper penetrating hole 43 and/or the lower penetrating hole 44, as illustrated in FIG. 5A and FIG. 5B, a first concave portion 93 and/or a second concave portion 94 may be provided.

The first concave portion 93 has a concave shape hollowed from the outer surface (upper surface) to inside of the upper protruding wall 15. The shape of the first concave portion 93 in the plan view is, for example, the same as that of the upper penetrating hole 43.

The second concave portion 94 has a concave shape hollowed from the outer surface (lower surface) to inside of the lower protruding wall 16. The shape of the second concave portion 94 in the bottom view is, for example, the same as that of the lower penetrating hole 44.

With the connector 1, the user can surely move the case 3 along the longitudinal direction by pinching the third wall 33 and the fourth wall 34 with the thumb and the middle finger and putting the index finger into the first concave portion 93.

With the connector 1, when a force acts downstream in the protruding direction by hooking the finger into the first rear edge 35, the force acting in the withdrawal direction is increased, and the terminal 31 can smoothly be withdrawn from the insertion terminal 84.

Furthermore, in the embodiment, the optical fiber cable 2 includes the optical fiber 5. However, for example, the optical fiber cable 2 may include an opto-electrical fiber cable (opto-electrical hybrid fiber cable) including the optical fiber 5 and electrical wiring (not illustrated) parallel with the optical fiber 5.

Furthermore, the accommodating portion 7, protruding portion 8, and protective portion 30 of the case 3 consist of the upper portion 81 and the lower portion 82. However, although not illustrated, for example, the accommodating portion 7, protruding portion 8, and protective portion 30 of the case 3 can integrally be formed from one member.

The optical fiber cable 2 may include a plurality of the optical fibers 5.

While the illustrative embodiments of the present invention are provided in the above description, such is for illustrative purpose only and it is not to be construed as limiting in any manner Modification and variation of the present invention that will be obvious to those skilled in the art is to be covered by the following claims.

### INDUSTRIAL APPLICABILITY

The connector of the present invention is used for optics application.

### DESCRIPTION OF REFERENCE NUMERALS

1 connector

2 optical fiber cable

3 case

5 optical fiber

9 rear wall

11 upper end

12 lower end

15 upper protruding wall

16 lower protruding wall

18 upper free end

19 lower free end

21 both upper protruding sides

23 both lower protruding sides

26 first space

31 terminal

33 third wall

34 fourth wall

35 first rear edge

36 second rear edge

43 first penetrating hole

44 second penetrating hole

50 printed wiring board

56 photoelectric conversion member

93 first concave portion

94 second concave portion

1. A connector for converting an optical signal input from an optical fiber into an electrical signal and outputting the electrical signal electrical signal or converting an input electrical signal into an optical signal and outputting the optical signal to the optical fiber, the connector comprising:
the optical fiber; and
a case accommodating one edge in a longitudinal direction of the optical fiber in the case, wherein
the case has a case wall into which the optical fiber is inserted,
the case wall has a first end and a second end facing each other with a space so that the optical fiber intervenes between the first end and the second end,
the case further includes:
a first wall protruding from the first end along a moving away direction in which the optical fiber moves away from the case wall; and
a second wall protruding from the second end along the moving away direction, and
a space is defined between a free end in a protruding direction in which the first wall protrudes and a free end in a protruding direction in which the second wall protrudes so that the optical fiber passing between the free ends can freely move in an orthogonal direction orthogonal to a facing direction in which the first wall faces the second wall and both of the protruding directions of the first wall and the second wall.

2. The connector according to claim 1, further comprising a printed wiring board in the case, wherein
the one edge in the longitudinal direction of the optical fiber is connected to the printed wiring board,
a photoelectric conversion member is mounted on the printed wiring board, and
the printed wiring board is disposed along the orthogonal direction.

3. The connector according to claim 2, further comprising a terminal connected to the printed wiring board and capable of inputting and outputting the electrical signal, wherein
the terminal protrudes from the case in a reverse direction of the protruding directions,
a length in the orthogonal direction of the terminal is longer than a length in the facing direction of the terminal.

4. The connector according to claim 1, further comprising:
a third wall connecting an end in the orthogonal direction of the first wall to an end in the orthogonal direction of the second wall, and
a fourth wall connecting the other end in the orthogonal direction of the first wall to the other end in the orthogonal direction of the second wall.

5. The connector according to claim 4, wherein the first wall and/or the second wall each have/has a penetrating hole penetrating in a thickness direction.

6. The connector according to claim 5, wherein a peripheral edge defining the penetrating hole includes a downstream edge in the protruding direction, and the downstream edge in the protruding direction has an approximately straight line shape along the orthogonal direction.

7. The connector according to claim 4, wherein the first wall and/or the second wall each have/has a concave portion hollowed from an outer surface toward an inside in the facing direction.

8. The connector according to claim 7, wherein a peripheral edge defining the concave portion includes a downstream edge in the protruding direction, and the downstream edge in the protruding direction has an approximately straight line along the orthogonal direction.

9. The connector according to claim 1, wherein the first wall and the second wall have a flexural modulus of 3 GPa or more at 25° C.
